(19) United States
(12) Patent Application Publication
(10) Pub. No.: US 2024/0427401 A1
(43) Pub. Date: Dec. 26, 2024

(54) EXTERNAL DISPLAY DEVICE AUXILIARY POWER MECHANISM DURING POWER OUTAGE

(71) Applicant: DELL PRODUCTS L.P., Round Rock, TX (US)

(72) Inventors: Daniel L. Hamlin, Round Rock, TX (US); Frank Quintanilla, III, Cedar Park, TX (US); Marcin Nowak, Round Rock, TX (US); Vivek Bhargava, Bangalore (IN)

(21) Appl. No.: 18/337,885

(22) Filed: Jun. 20, 2023

(51) Int. Cl. G06F 1/30

(52) U.S. Cl. CPC G06F 1/30

(57) ABSTRACT

An information handling system detects whether there is a power loss from an alternating current power source. In response to detecting the power loss from the alternating current power source, the system transmits a power loss signal to a display device that is coupled to the information handling system, and provides auxiliary power to the display device during the power loss.

### FIELD OF THE DISCLOSURE

The present disclosure generally relates to information handling systems, and more particularly relates to an external display device auxiliary power mechanism during power outage.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system detects whether there is a power loss from an alternating current power source. In response to detecting the power loss from the alternating current power source, the system transmits a power loss signal to a display device that is coupled to the information handling system, and provides auxiliary power to the display device during the power loss.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system, according to an embodiment of the present disclosure;

FIGS. 2-4 are diagrams of an information handling system and associated external display devices, according to embodiments of the present disclosure;

FIGS. 5-7 are diagrams of an information handling system and associated external display devices, according to embodiments of the present disclosure;

FIG. 8 is a flowchart illustrating a method for an information handling system to power an external display device during a power outage, according to an embodiment of the present disclosure;

FIG. 9 is a flowchart illustrating a method where an information handling system and associated external display device each have sufficient auxiliary power during a power outage, according to an embodiment of the present disclosure;

FIG. 10 is a flowchart illustrating a method for sustainable auxiliary power management, according to an embodiment of the present disclosure; and

FIG. 11 is a flowchart illustrating a method for an external display device to power an information handling system during a power outage, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

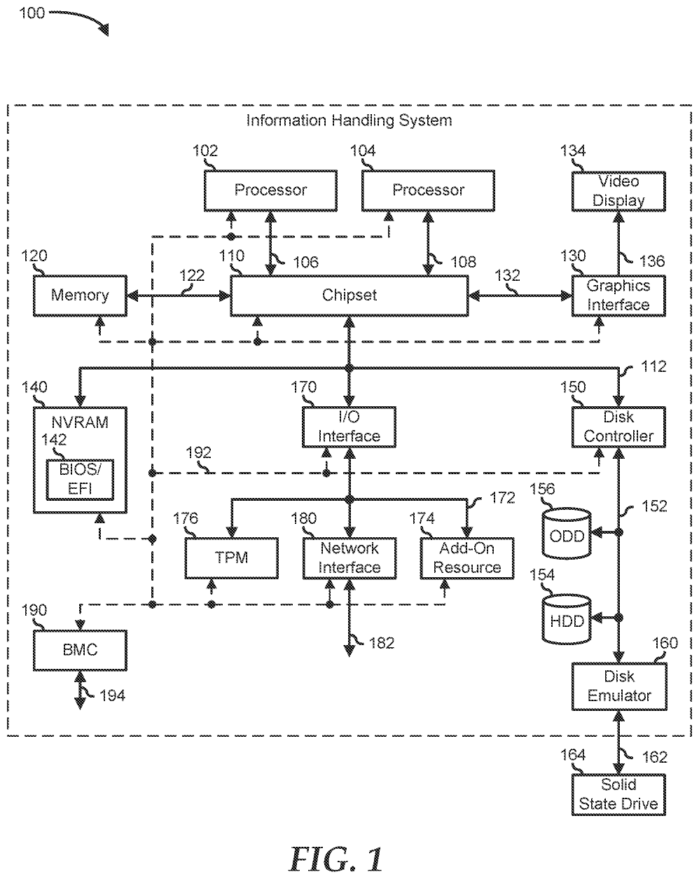

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a double data rate (DDR) memory channel and memory 120 represents one or more DDR dual in-line memory modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as dynamic random access memory (DRAM) DIMMs, static random access memory (SRAM) DIMMs, non-volatile DIMMs (NV-DIMMs), storage class memory devices, read-only memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Portable information handling systems may not have a backup power source. In addition, external display devices generally do not have a battery. Therefore during an outage of an active power source, the display device may lose power while the portable information handling system automatically switches to using its battery. To address this and other concerns, a seamless automated mechanism for the external display device to utilize the battery power of the portable information handling system as a backup power source is disclosed herein.

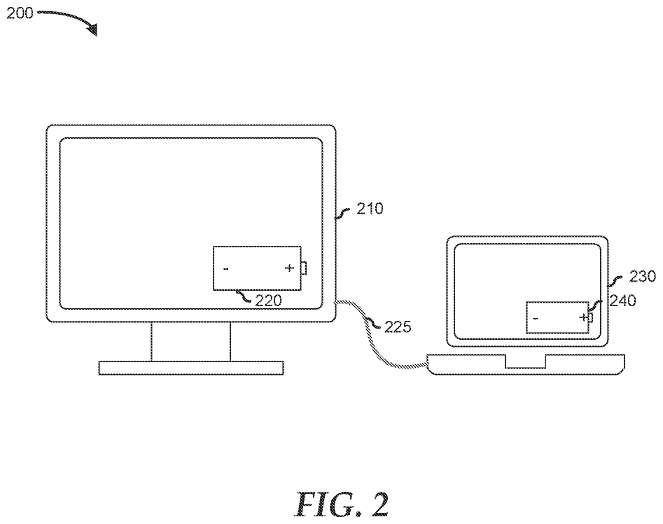

FIG. 2 shows an environment 200 that includes a display device 210 connected to an information handling system 230 via a cable 225. Display device 210 includes a power source 220. Display device 210 may comprise any suitable system, device, or apparatus configured to display human perceptible graphical data and/or alphanumeric data to a user. Display device 210 may be a conventional flat display monitor or similar. For example, in some embodiments, display device 210 may comprise a liquid crystal display, a light-emitting diode display, or similar.

Power sources 220 and 240 may be internal batteries or capacitors that may provide auxiliary electrical DC power to display device 210 and information handling system 230 respectively. In one example, power sources 220 and 240 may be single-cell or multiple-cell batteries that can provide DC power ranging from six to sixty watts or so. In another example, power source 220 may be a high-capacity capacitor, such as a super capacitor, or any other suitable power source. Typically, display device 210 may use an alternating current (AC) power source for its operation. When a power outage occurs, a circuit in display device 210, such as power delivery controller 335 and/or scalar 325, may detect the power outage, switch to power source 220, and notify information handling system 230 of the power outage. For example, display device 210 may send a “power loss” signal to information handling system 230 via cable 225. Display device 210 may also set brightness and refresh rate to lowest possible values. Accordingly, when the power outage occurs, a circuit in information handling system 230 may detect the power outage, switch to power source 240, and notify display device 210 of the power outage. For example, information handling system 230 may send a power loss signal to display device 210 via cable 225. Information handling system 230 may also switch to a low-power state.

Information handling system 230, which is similar to information handling system 100 of FIG. 1, may be a portable information handling system such as a personal computer, a laptop computer, a tablet computer, or similar. Typically, information handling system 230 may also use AC power or its own internal DC power source for its operation. When a power outage occurs, a circuit in information handling system 230 may detect the power outage, and switch to its internal DC power source. Information handling system 230 may also receive the power loss signal transmitted by display device 210. After detecting the power outage and/or receiving the power loss signal from display device 210, information handling system 230 may place the system in a low-power state to conserve energy.

While operating in the low-power state, information handling system 230 may conserve power by turning off various internal components of information handling system 230. Information handling system 230 may also conserve power by setting CPU speed to a minimum, placing its RAM to a minimum power state, etc. Information handling system 230 may also provide power to display device 210 using its internal battery via cable 225. Accordingly, display device 210 may switch from using power source 220 to using information handling system 230 as a power source. As such, a user may avoid interruption and continuation of work, such as providing a presentation at a meeting using display device 210 is maintained.

When power is restored, display device 210 and/or information handling system 230 may detect the power restoration. Display device 210 may also notify information handling system 230 of the power restoration by sending a “power restore” signal. In response to detecting that the power is restored and/or receipt of the power restore signal, information handling system 230 may revert its changed settings to previous settings. For example, information handling system 230 may turn back on the components that were turned off during the power outage. In addition, information handling system 230 may revert the CPU speed and the power state of its RAM.

Cable 225 may be a USB Type-C cable or similar, wherein its specified power rating may conform to a Type-C specification. Accordingly, cable 225 may support device detection, interface configuration, communication, and power delivery mechanisms according to USB Type-C standard. As such, cable 225 may allow the transport of data and DC power between various USB devices that are connected using USB Type-C ports and USB Type-C connectors. In this example, cable interfaces 340 and 355 may be USB Type-C ports.

A USB device may be an information handling system, a peripheral device, a power device, etc., and may support one or more types of physical USB ports and corresponding connectors, such as Type-A, Type-A SuperSpeed, Type-B, Type-B SuperSpeed, Mini-A, Mini-B, Micro-A, Micro-B, Micro-B SuperSpeed, and Type-C (also referred to as USB Type-C herein), among other variants. A USB device operating as a dual-role power device may operate as a power source or a power sink depending on what kinds of other USB devices are connected. In addition, each of the power ports provided by a USB device may be a dual-role power port that can operate as either a power source port or a power sink port. For example, a USB Type-C bus carried over a power cable may support power delivery from a power source port of a power source USB device to a power sink port of a power sink USB device, while simultaneously supporting bidirectional USB data transport. The power source port of the power source USB device and the power sink port of the power sink USB device form a power port pair. Each of the other power ports provided by the USB device may form other power port pairs of other USB dual-role power devices.

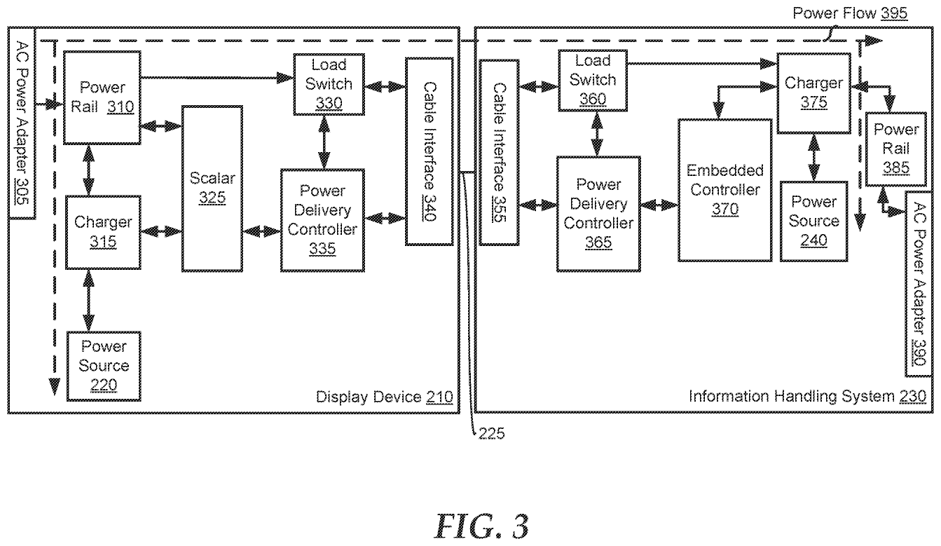

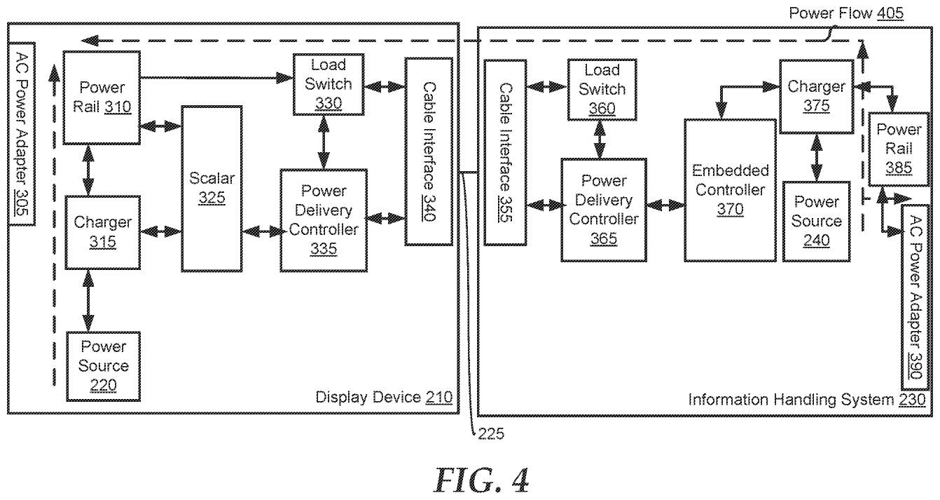

FIGS. 3 and 4 show block diagrams of environment 200 in greater detail. In this example, display device 210 includes an AC power adapter 305, a power rail 310, a charger 315, power source 220, a scalar 325, a load switch 330, a power delivery controller 335, and a cable interface 340. Information handling system 230 includes a cable interface 355, a load switch 360, a power delivery controller 365, an embedded controller 370, a charger 375, a power source 240, a power rail 385, and an AC power adapter 390. Embedded controller 370 may be similar to BMC 190 of FIG. 1.

Power delivery controller 335 may be coupled to power rail 310, scalar 325, load switch 330, and cable interface 340. Scalar 325 may be coupled to power rail 310, charger 315, and power delivery controller 335. Power rail 310 may be coupled to AC power adapter 305, load switch 330, and charger 315. Load switch 330 may be coupled to power rail 310, power delivery controller 335, and cable interface 340.

Cable interface 355 may be coupled to load switch 360 and power delivery controller 365. Load switch 360 may be coupled to charger 375 and power delivery controller 365. Power delivery controller 365 may be coupled to load switch 360, embedded controller 370, and charger 375. Embedded controller 370 may be coupled to power delivery controller 365 and charger 375. Charger 375 may be coupled with power source 240 and power rail 385. Power rail 385 may be coupled to AC power adapter 390.

Scalar 325 is a video processing unit that may be configured to process incoming video stream and render images on display device 210 using one of various protocols such as DisplayPort™ protocol, HDMI protocol, or similar. Scalar 325 may also be configured to execute customizable firmware and act as an embedded controller for display device 210. For example, scalar 325 may be configured to manage or control power and other signals associated with display device 210. Similarly, embedded controller 370 may be configured to manage or control power and other signals associated with various components of information handling system 230. For example, embedded controller 370 may be configured to control power distribution to power delivery controller 365, charger 375, load switch 360, and power source 240.

Power delivery controllers 335 and 365 may be one of several types of power delivery controllers, such as a USB Type-C power delivery controller. As such, power delivery controller 335 may be configured to enable/disable protocols supported by a USB Type-C port, such as cable interfaces 340 and 355. In various embodiments, power delivery controllers 335 and 365 may be implemented by program instructions executing on a local processor or microcontroller by dedicated hardware circuitry, or by a combination of hardware and software elements to perform the functionality of power delivery controllers 335 and 365.

Power delivery controllers 335 and 365 may be configured to negotiate power and data contracts. For example, power delivery controllers 335 and 365 may determine power and data inputs and/or outputs and data that are available in data lines. For example, power delivery controller 335 may be configured to manage connection and information exchange between components of display device 210. While power delivery controller 365 may be configured to manage connection and information exchange between components of information handling system 230.

Power delivery controllers 335 and 365 may be configured for negotiating and managing power contracts and data modes, such as video/audio stream and USB data, with downstream devices. For example, power delivery controller 335 may determine what contract to negotiate and how to enable load switch 330 to either accept power from the AC power source via power rail 310 or to accept power from power source 220. Power delivery controller 335 may determine how to perform various functions based on a platform policy and/or contract that may have been loaded by scalar 325. In another example, power delivery controller 365 may determine what contract to negotiate and how to enable load switch 360 to either accept power from the AC power source via power rail 385 or to accept power from power source 240. Power delivery controller 365 may determine how to perform various functions based on a platform policy and/or contract that may have been loaded by embedded controller 370.

Power delivery controllers 335 and 365 may be configured to negotiate power and data between various components of display device 210 and information handling system 230 respectively. Power delivery controllers 335 and 365 may also be configured to manage power signal(s) between display device 210 and information handling system 230. For example, power and battery status information may be transferred from display device 210 to information handling system 230 and vice versa. Power delivery controller 335 may decode packets received associated with a status of AC power and/or power source 220 and report the information to components of display device 210 and/or information handling system 230.

Similarly, power delivery controller 365 may decode packets received associated with a status of AC power and/or power source 240 and report the information to components of information handling system 230 and/or display device 210. In another example, power delivery controller 335 may provide a signal to scalar 325 when a new connection to display device 210 is detected. For example, power delivery controller 335 may detect when cable 225 is connected to display device 210. Similarly, power delivery controller 365 may provide a signal to embedded controller 370 when a new connection to information handling system 230 is detected. For example, power delivery controller 365 may detect when cable 225 is connected to information handling system 230.

Load switch 360 may be configured to act as a power gate, wherein load switch 360 may determine whether to allow power in or power out at information handling system 230. Load switch 360 may include built-in reverse current protection. Load switch 360 may determine power input and/or output based on a control signal from power delivery controller 365 and/or embedded controller 370, wherein power delivery controller 365 has direct control but embedded controller 370 may have an override authority.

Power rail 385 may be configured to distribute power from power source 240 or AC power source to various components of information handling system 230, such as load switch 360, power delivery controller 365, embedded controller 370, and charger 375. Charger 375 may be configured to charge power source 240, which is typically based on a control signal from embedded controller 370.

Referring to FIG. 3, display device 210 may be connected to an AC power source via AC power adapter 305. The AC power may provide power to various components of display device 210 via power rail 310 as depicted by a power flow 395. In addition, the AC power may be used to charge power source 220 via charger 315. Power rail 310 may be configured to distribute power from the AC power source to various components of display device 210, such as load switch 330, scalar 325, and charger 315. Load switch 330 may be configured to act as a power gate, wherein load switch 330 may determine whether to allow power in or power out at display device 210. For example, load switch 330 may provide power when a control signal is active. The control signal may be provided by power delivery controller 335 and/or scalar 325. Charger 315 may be configured to charge power source 220, which is typically based on a control signal from scalar 325. Charger 315 may be configured to aggregate power from the AC power source and power source 220.

Information handling system 230 may be connected to the AC power source via AC power adapter 390. The AC power may provide power to various components of information handling system 230 via power rail 385. In addition, the AC power may be used to charge power source 240 via charger 375. Power rail 385 may be configured to distribute power from the AC power source to various components of information handling system 230, such as load switch 360, embedded controller 370, and charger 375. Load switch 360 may be configured to act as a power gate, wherein load switch 360 may determine whether to allow power in or power out at information handling system 230. For example, load switch 360 may provide power when a control signal is active. The control signal may be provided by power delivery controller 365 and/or embedded controller 370. Charger 375 may be configured to charge power source 240, which is typically based on a control signal from embedded controller 370. Charger 375 may be configured to aggregate power from the AC power source and power source 240.

Referring to FIG. 4, when a power outage occurs, information handling system 230 may transmit a power loss signal to display device 210. Power delivery controller 335 may be configured to detect the AC power loss signal. Power delivery controller 335 may also determine the capacity and/or charge level of power source 220. Power delivery controller 335 may also determine whether power source 220 can adequately provide enough power to display device 210. In this scenario, power delivery controller 635 may determine that the available charge of power source 220 may not exceed a threshold sufficient to provide power to display device 210 for a period of time during the power outage.

Accordingly, subsequent to detecting the AC power loss signal, power delivery controller 335 may renegotiate a power contract between power delivery controller 335 and other components of display device 210. For example, display device 210 may switch to power source 220 for power. Display device 210 may also renegotiate a power contract with information handling system 230 allowing display device 210 and information handling system 230 to switch roles and power flow. For example, as depicted by power flow 395, display device 210 may act as a power source and may supply power to information handling system 230. During the power outage, information handling system 230 acts as a power source and supply power to display device 210 as depicted in power flow 405. In addition, power source 240 of information handling system 230 may also provide power to its components via power rail 385.

In this scenario, information handling system 230 may change roles from being a power consumer or a sink to providing power or a power source. Accordingly, the direction of the power flow may change direction, such as depicted from power flow 395 to power flow 405. Power may be transmitted by information handling system 230 to display device 210 via cable 225 through cable interfaces 355 and 340. Accordingly, load switch 330 may be re-configured by power delivery controller 335 to allow the power input from information handling system 230 and use this power input to supply power to various components of display device 210. The change of roles may be performed so that display device 210 does not lose power during the power outage even with a limited capacity of power source 220. Power source 220 may act as a power source to display device 210 during the renegotiation process. However, because power source 220 has a relatively low power capacity, power source 220 may be able to provide power to display device 210 for a limited duration until information handling system 230 can provide power to display device 210.

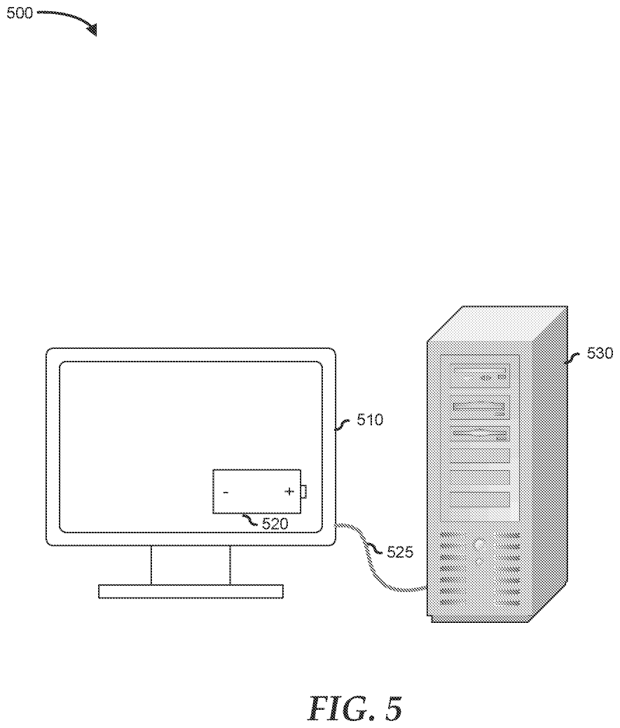

FIG. 5 shows an environment 500 of an information handling system and associated external display device. Environment 500 includes a display device 510 that is connected to an information handling system 530 via a cable 525. Display device 510 may be similar to display device 210 of FIG. 2. Display device 510 includes a power source 520 which is an auxiliary power source, also referred to as an alternate power source, that is similar to power source 220 of FIG. 2. However, power source 520 may have a higher capacity than power source 220. For example, instead of having a capacity of 15 watts, power source 520 may have a capacity of 60 watts or higher. Information handling system 230, which is similar to information handling system 100 of FIG. 1, may be a desktop computer or a server and may or may not have an internal power source, such as a battery. Information handling system 230 may be connected to display device 510 via cable 525, which is similar to cable 225 of FIG. 2. Instead of being connected to display device 510 via a Type-C port, cable 525 may be connected to display device 510 via a USB hub. The USB hub may include at least one USB Type-C port which may be utilized as a docking connector.

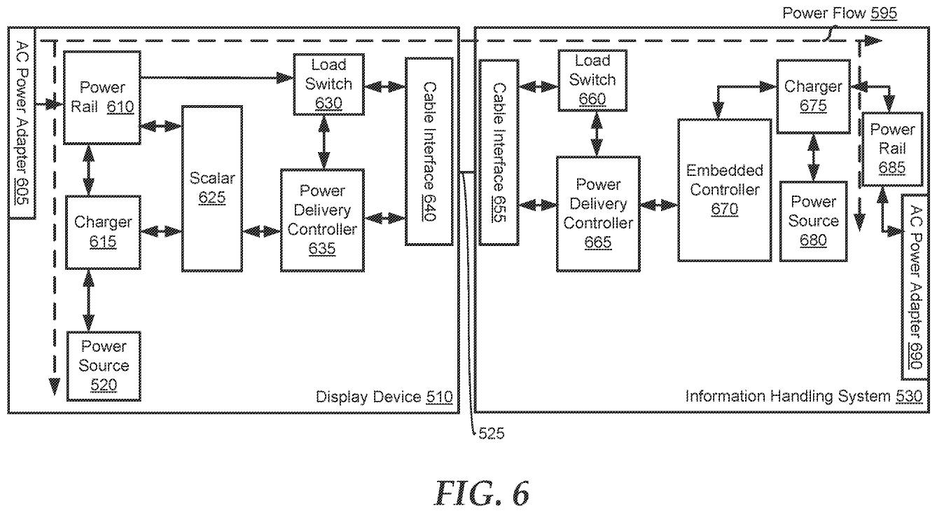

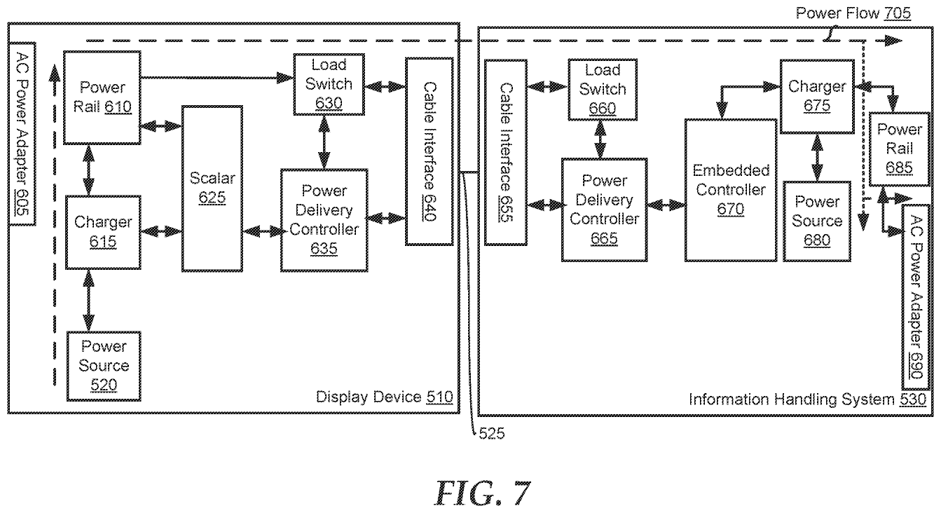

FIGS. 6 and 7 show block diagrams of environment 500 in greater detail. In this example, display device 510 includes an AC power adapter 605, a power rail 610, a charger 615, power source 520, a scalar 625, a load switch 630, a power delivery controller 635, and a cable interface 640. Information handling system 530 includes a cable interface 655, a load switch 660, a power delivery controller 665, an embedded controller 670, a charger 675, a power source 680, a power rail 685, and an AC power adapter 690. Embedded controller 670 may be similar to embedded controller 370 of FIG. 3. Display device 510 may be similar to display device 210. Accordingly, the components of display device 510 depicted herein may be similar to the components of display device 210 except for power source 520. In this example, power source 520 may have a higher capacity than power source 220. In addition, the flow of power depicted in power flow 595 may be similar to power flow 395.

Power delivery controller 635 may be coupled to power rail 610, scalar 625, load switch 630, and cable interface 640. Scalar 625 may be coupled to power rail 610, charger 615, and power delivery controller 635. Power rail 610 may be coupled to AC power adapter 605, load switch 630, and charger 615. Load switch 630 may be coupled to power rail 610, power delivery controller 635, and cable interface 640.

Cable interface 655 may be coupled to load switch 660 and power delivery controller 665. Load switch 660 may be coupled to charger 675 and power delivery controller. Power delivery controller 665 may be coupled to load switch 660, embedded controller 670, and charger 675. Embedded controller 670 may be coupled to power delivery controller 665, and charger 675. Charger 675 may be coupled with power source 680 and power rail 685. Power rail 685 may be coupled to AC power adapter 690.

Referring to FIG. 7, when a power outage occurs, information handling system 530 may transmit a power loss signal to display device 510. Power delivery controller 335 may be configured to detect the AC power loss signal. Power delivery controller 635 may also determine the capacity and/or charge level of power source 520. Power delivery controller 635 may also determine whether power source 520 can adequately provide enough power to display device 510. In this scenario, power delivery controller 635 may determine that the available charge of power source 520 may exceed a threshold sufficient to provide power to display device 210 for a period of time during the power outage.

Accordingly, subsequent to detecting the AC power loss signal, power delivery controller 635 may not renegotiate a power contract between power delivery controller 635 and other components of display device 510. Power delivery controller 335 may also not renegotiate the power supply contract between display device 510 and information handling system 530 as power source 520 can support the power requirements of display device 510 for a period of time during the power outage. In this scenario, display device 510 may not swap roles with information handling system 230. Information handling system 530 may derive its power requirements from power source 680 for a period of time during the power outage. Display device 510 may also supply power to information handling system 530 via power rail 685 when it is determined that power source 680 may no longer have enough power for information handling system 530 for a period of time during the power outage as depicted in power flow 705. Display device 510 may also charge power source 680.

For example, instead of a power consumption of 100 watts when the AC power source is available, power delivery controller 635 may limit power consumption to 65 watts, such as by dimming its display screen. Power delivery controller 635 may monitor the power capacity and/or availability of power source 520. This may continue while power source 520 has enough power allowing a user to continue with the current work item, increasing productivity and avoiding data loss. However, when the power level of power source 520 reaches below a threshold, power delivery controller 635 may initiate the sourcing of its power needs from information handling system 530, by swapping power roles with information handling system 530 as discussed above.

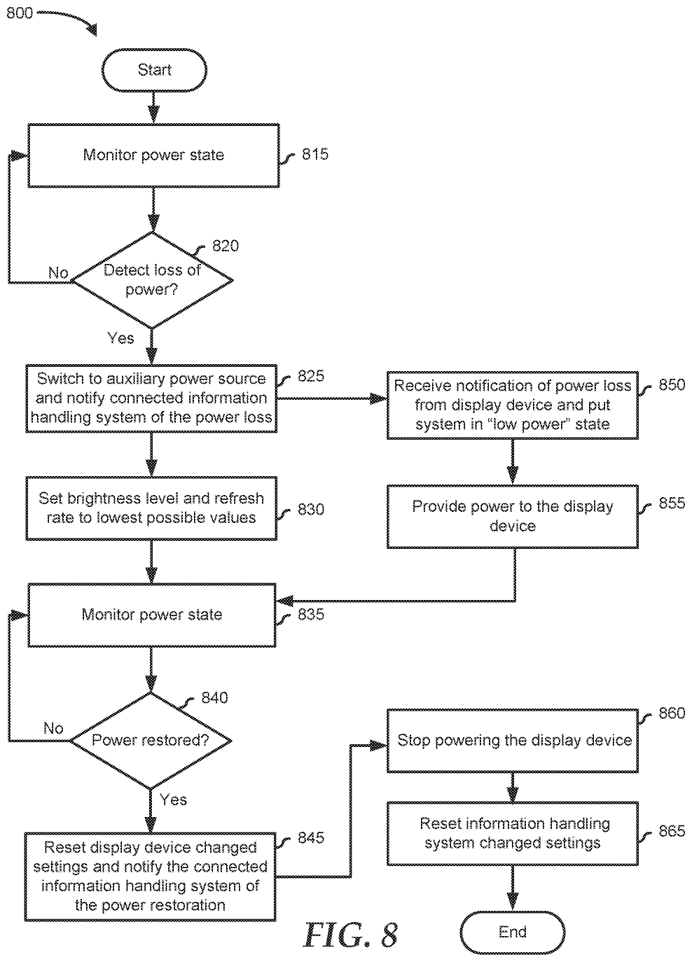

FIG. 8 shows a method 800 for an information handling system to power an external display device during a power outage. Method 800 may be performed by display device 210 and information handling system 230 of FIG. 4. Display device 210 may be an external display device, such as a display monitor, that is configured to display information that includes video and graphics from information handling system 230. Display device 210 may be connected to information handling system 230 via a cable, that can carry data and power to and from information handling system 230a. The cable may be similar to cable 225 of FIG. 4.

In this scenario, an internal power source of display device 805 may not have enough power to supply display device 805 for a period of time during a power outage. Method 800 may be performed by one or more components of FIG. 4. However, while embodiments of the present disclosure are described in terms of the environment of FIG. 4, it should be recognized that other systems may be utilized to perform the described method. One of skill in the art will appreciate that this flowchart explains a typical example, which can be extended to advanced applications or services in practice.

Method 800 typically starts at block 815 where display device 805 may monitor its power state. The method may proceed to decision block 820 to determine whether it detects a loss of power. If a power loss is detected, then the “YES” branch is taken, and the method proceeds to block 825. If power loss is not detected, the “NO” branch is taken, and the method proceeds to block 815.

At block 825, the method may switch display device 805 to switch to auxiliary power, such as battery power. Display device 805 may also send a notification to inform information handling system 810 of the power outage. For example, display device 805 may send a “power loss” signal to information handling system 510.

At block 830, the method may set the brightness level and refresh rate of display device 805 to lowest possible values. The method proceeds to block 835 where the method monitors the power state of display device 805. The method proceeds to decision block 840, where the method may determine whether the power is restored. If the power is restored, then the “YES” branch is taken, and the method proceeds to block 845. If the power is not restored, then the “NO” branch is taken, and the method proceeds to block 835. At block 845, the method may reset display device settings that were changed at block 830. For example, the brightness level and the refresh rate may be restored to prior settings before the power outage. The method may also send a “power restored” signal to information handling system 810.

At block 850, information handling system 810 may receive notification of the power loss from display device 805, such as a “power loss” signal. After receiving the notification, the method may put the information handling system in a “low power” state. For example, the method may put the information handling system in a low-power idle mode. The method may also change one or more settings, such as reducing the power consumption of the CPU. The method proceeds to block 855 where it uses information handling system 810 as an auxiliary power, providing power to display device 805. The method may proceed to block 835.

At block 860, where information handling system 810 may receive notification of the power outage from display device 805. After receiving the notification, information handling system 810 may put the system in a “low power” state. The method proceeds to 865 where the information handling system 810 may reset settings of the information handling system that were changed when the system was put in a low power state at block 850. For example, information handling system 810 may be restored to a working state from the low power state.

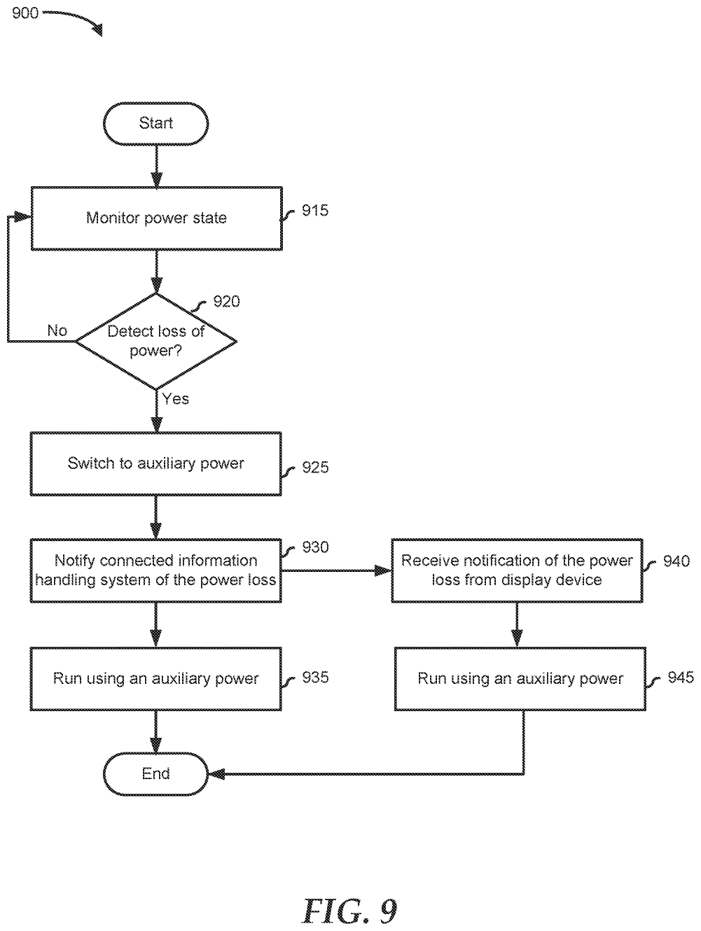

FIG. 9 shows a method 900 where both the information handling system and associated external display device each have enough auxiliary power during a power outage. Method 900 may be performed by display device 905 and information handling system 910. Display device 905 may be an external display device that is similar to display device 805. Display device 510 may be connected to information handling system 910 via a cable, that can carry data and power to and from information handling system 910. In this scenario, an internal power source of display device 805 may have enough power to supply itself display device 805 for a period of time during a power outage. One of skill in the art will appreciate that this flowchart explains a typical example, which can be extended to advanced applications or services in practice.

Method 900 typically starts at block 915 where a display device may monitor its power state. The method may proceed to decision block 920 to determine whether it detects a loss of power. If a power loss is detected, then the “YES” branch is taken, and the method proceeds to block 925. If power loss is not detected, the “NO” branch is taken, and the method proceeds to block 915.

At block 925, the method may switch the display device to switch to auxiliary power, such as battery power. The method proceeds to block 930, where display device 905 may send a notification to inform information handling system 910 of the power outage. For example, display device 905 may send a “power loss” signal to information handling system 910. The method proceeds to block 940 and block 935.

At block 935, the display device runs using auxiliary power. At block 940, information handling system 910 may receive the notification of the power loss from display device 905. For example, information handling system 910 may receive a power loss signal. In another embodiment, information handling system 910 may also detect the power outage and transmit a power loss signal to display device 905. The method may proceed to block 945 where information handling system 910 may run on auxiliary power.

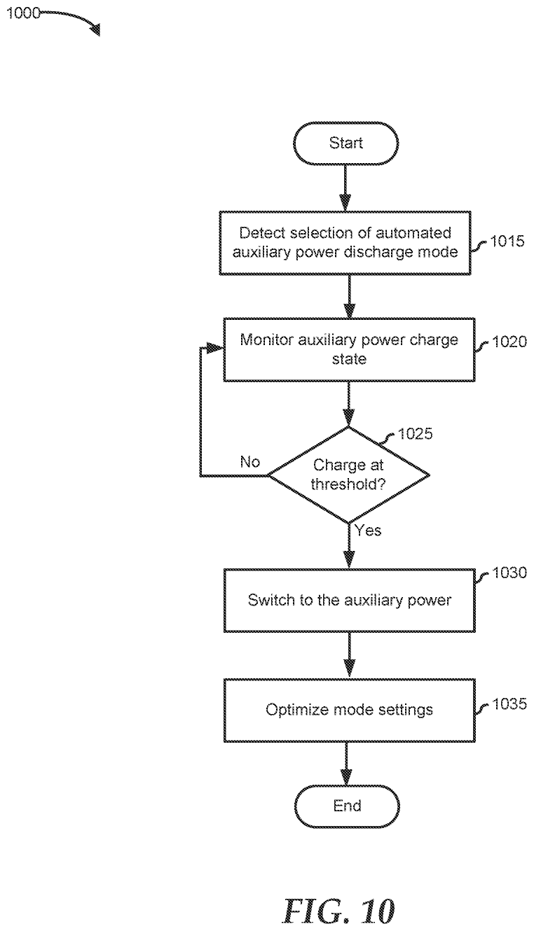

FIG. 10 shows a method 1000 for sustainable auxiliary power management. Method 1000 may be performed by a display device and an information handling system. The display device may be an external display device that is similar to display device 510 of FIG. 5 or display device 210 of FIG. 2. The display device may be connected to the information handling system via a cable, that can carry data and power to and from the information handling system. The information handling system may also have an internal display device. One of skill in the art will appreciate that this flowchart explains a typical example, which can be extended to advanced applications or services in practice.

Method 1000 typically starts at block 1015 where it may detect the selection of automated discharge mode of an auxiliary power source, such as a battery, for a display device and/or information handling system. The selection may be performed by a user or selected automatically by an application based on the geographical location of the display device and/or information handling system. The selection may also be based on other factors, such as the age of the auxiliary power source. For example, the discharge mode may be set to a pre-determined discharge period. The discharge may also be performed by the auxiliary power until it reaches a certain capacity percentage.

The method proceeds to block 1020 where it may monitor the charge state of the auxiliary power source of the display device and/or information handling system. The method may proceed to decision block 1025 to determine whether the charge is equal to or less than a threshold. The threshold may be the pre-determined period or capacity percentage. If the time period and/or charge is equal to or less than the threshold, then the “YES” branch is taken, and the method proceeds to block 1030. If power loss is not detected, the “NO” branch is taken, and the method proceeds to block 1020.

At block 1030, the display device and/or information may switch to battery power. The method proceeds to block 1035 where the method may optimize mode settings. For example, the method may set the brightness level and refresh rate of the display device to the lowest possible settings. In addition, the method may put the information handling system in a low-power state.

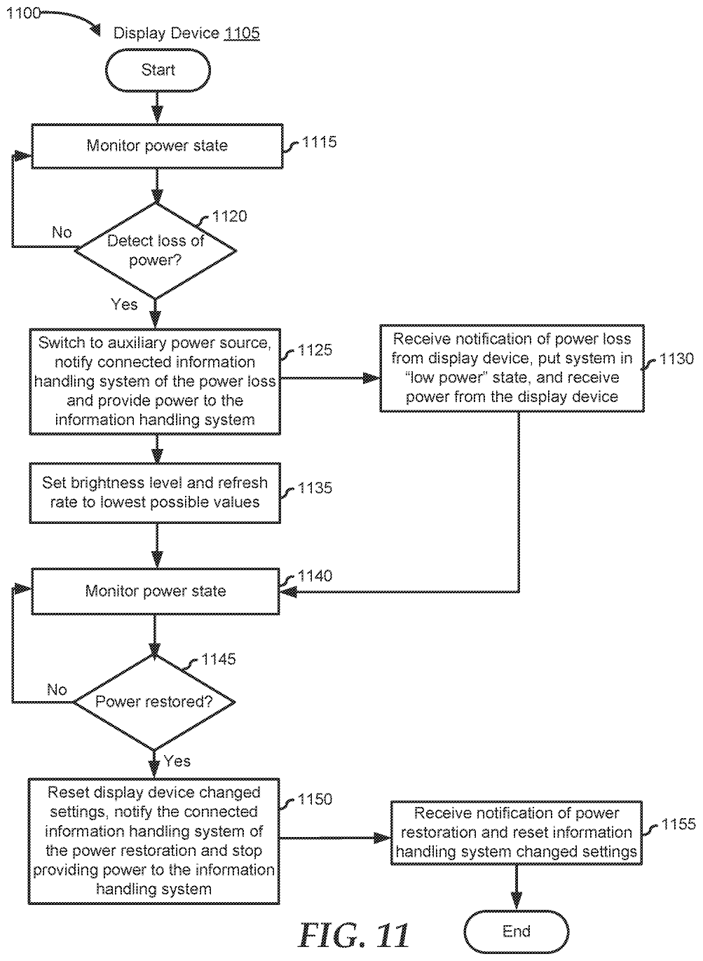

FIG. 11 shows a method 1100 for an external display device to power the associated information handling system during a power outage. Method 1100 may be performed by display device 1105, which is similar to display device 510 of FIG. 7, and information handling system 1110, which is similar to information handling system 530 of FIG. 7. Display device 1105 may be an external display device, such as a display monitor, that is configured to display information that includes video and graphics from information handling system 1110. Display device 1105 may be connected to information handling system 1110 via a cable, that can carry data and power to and from information handling system 1110. The cable may be similar to cable 525 of FIG. 7.

In this scenario, an internal power source of display device 1105 may have enough power to supply display device 1105 and information handling system 1110 for a period of time during a power outage. Method 1100 may be performed by one or more components of FIG. 7. However, while embodiments of the present disclosure are described in terms of the environment of FIG. 7, it should be recognized that other systems may be utilized to perform the described method. One of skill in the art will appreciate that this flowchart explains a typical example, which can be extended to advanced applications or services in practice.

Method 1100 typically starts at block 1115 where display device 1105 may monitor its power state. The method may proceed to decision block 1120 to determine whether it detects a loss of power. If a power loss is detected, then the “YES” branch is taken, and the method proceeds to block 1125. If power loss is not detected, the “NO” branch is taken, and the method proceeds to block 1115.

At block 1125, the method may switch display device 805 to switch to auxiliary power, such as battery power. Display device 1105 may also send a notification to inform information handling system 1110 of the power outage. For example, display device 1105 may send a “power loss” signal to information handling system 1110. In addition, display device 1105 may also provide power to information handling system 1110. At block 1130, information handling system 1110 may receive the notification of power loss from display device 1105. Information handling system 1110 may also receive power from display device 1105.

At block 1135, the method may set the brightness level and refresh rate of display device 1105 to lowest possible values. The method proceeds to block 1140 where the method monitors the power state of display device 1105. The method proceeds to decision block 1145, where the method may determine whether the power is restored. If the power is restored, then the “YES” branch is taken, and the method proceeds to block 1150. If the power is not restored, then the “NO” branch is taken, and the method proceeds to block 1140. At block 1150, the method may reset display device settings that were changed at block 1135, such as the brightness level and the refresh rate. The method may also send a “power restored” signal to information handling system 1110. Display device 1105 may also stop providing power to information handling system 1110. At block 1155, information handling system 1110 may receive notification of power restoration and reset its changed settings associated with the low power state back to a normal state.

Although FIG. 8, FIG. 9, FIG. 10, and FIG. 11 show example blocks of method 800, method 900, method 1000, and method 1100 in some implementations, method 800, method 900, method 1000, and method 1100 may include additional blocks, fewer blocks, different blocks, or differently arranged blocks than those depicted in FIG. 8, FIG. 9, FIG. 10, and FIG. 11. Those skilled in the art will understand that the principles presented herein may be implemented in any suitably arranged processing system. Additionally, or alternatively, two or more of the blocks of method 800, method 900, method 1000, and method 1100 may be performed in parallel. For example, blocks 825 and 830 of method 800 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
monitoring a display device, by a processor, to detect whether there is a power loss from an alternating current power source;
in response to detecting the power loss from the alternating current power source, transmitting a power loss signal to an information handling system that is coupled to the display device; and
providing auxiliary power to the information handling system.

2. The method of claim 1, wherein the information handling system is coupled to the display device via a Type-C cable.

3. The method of claim 1, further comprising switching to an auxiliary power source prior to the providing the auxiliary power to the information handling system.

4. The method of claim 1, further comprising setting a brightness level and a refresh rate of the display device to lowest possible values.

5. The method of claim 1, further comprising in response to detecting restoration of the alternating current power source, transmitting a power restored signal to the information handling system.

6. The method of claim 1, further comprising in response to detecting restoration of the alternating current power source, restoring setting of a brightness level and a refresh rate of the display device to prior settings before the power loss.

7. An information handling system, comprising:
a processor; and
a memory storing instructions that when executed cause the processor to perform operations, the operations including:
monitoring the information handling system to detect whether there is a power loss from an alternating current power source;
in response to detecting the power loss from the alternating current power source, transmitting a power loss signal to a display device that is coupled to the information handling system; and
providing auxiliary power to the display device during the power loss.

8. The information handling system of claim 7, wherein the information handling system and the display device are coupled via a Type-C cable.

9. The information handling system of claim 7, the operations further comprise switching to an auxiliary power source prior to the providing the auxiliary power to the display device.

10. The information handling system of claim 7, the operations further comprise switching to a low power state.

11. The information handling system of claim 7, the operations further comprise in response to detecting restoration of the alternating current power source, transmitting a power restored signal to the display device.

12. The information handling system of claim 7, the operations further comprise in response to detecting restoration of the alternating current power source, restoring the information handling system to a working state from a low power state.

13. The information handling system of claim 7, wherein an auxiliary power source of the display device provides power to the display device prior to the information handling system providing auxiliary power to the display device.

14. A non-transitory computer-readable medium to store instructions that are executable to perform operations comprising:
monitoring an information handling system to detect whether there is a power loss from an alternating current power source;
in response to detecting the power loss from the alternating current power source, transmitting a power loss signal to a display device that is coupled to the information handling system; and
providing auxiliary power to the display device during the power loss.

15. The non-transitory computer-readable medium of claim 14, wherein the information handling system and the display device are coupled via a Type-C cable.

16. The non-transitory computer-readable medium of claim 14, wherein the operations further comprise switching to an auxiliary power source prior to the providing the auxiliary power to the display device.

17. The non-transitory computer-readable medium of claim 14, wherein an auxiliary power source of the display device provides power to the display device prior to the information handling system providing auxiliary power to the display device.

18. The non-transitory computer-readable medium of claim 14, wherein the operations further comprise switching the information handling system to a low power state.

19. The non-transitory computer-readable medium of claim 14, wherein the operations further comprise in response to detecting restoration of the alternating current power source, transmitting a power restored signal to the information handling system.

20. The non-transitory computer-readable medium of claim 14, wherein the operations further comprise in response to detecting restoration of the alternating current power source, restoring the information handling system to a working state from a low power state.
